(19) United States
(12) Patent Application Publication
(10) Pub. No.: US 2026/0276473 A1
(43) Pub. Date: Sep. 17, 2026

(54) DETECTING DEVICE AND METHOD FOR INSPECTING THE SEAL-TIGHTNESS OF SEALED PRODUCTS

(71) Applicant: PFEIFFER VACUUM, Annecy (FR)

(72) Inventors: Julien PALISSON, Annecy Cedex (FR); Philippe BUNOD, Annecy Cedex (FR)

(73) Assignee: PFEIFFER VACUUM, Annecy (FR)

(21) Appl. No.: 19/472,857

(22) PCT Filed: Feb. 7, 2024
(86) PCT No.: PCT/EP2024/052991

§ 371 Date: Oct. 6, 2025

(30) Foreign Application Priority Data
Apr. 7, 2023 (FR) FR2303531

(51) Int. Cl. G01M 3/20; G01M 3/22

(52) U.S. Cl. CPC G01M 3/207; G01M 3/205; G01M 3/226

(57) ABSTRACT

A detecting device for inspecting the seal-tightness of sealed products includes an enclosure to receive at least one product that has been sealed under a nitrogen-containing atmosphere, a turbomolecular vacuum pump, an ionized gas gauge, a buffer volume fluidically connected to a chamber of the ionized gas gauge, an isolation valve interposed between the enclosure and the buffer volume and able to put in communication or isolate the buffer volume with/from the enclosure, a variable conductance restriction interposed between the inlet of the turbomolecular vacuum pump and the buffer volume having a variable aperture, and a gas-injecting device to inject a variable flow rate of substitution gas other than nitrogen into the enclosure containing the sealed product

### TECHNICAL FIELD OF THE INVENTION

The present invention relates to a detection device for checking the leaktightness of sealed products such as pharmaceutical or food products, or of products from the biotechnology industry, automotive industry, watchmaking industry or cosmetic industry. The present invention also relates to a detection method implemented in the device.

### TECHNICAL BACKGROUND

Certain products such as sealed blister packs, sachets, vials, pouches, pharmaceutical or medical bags, and syringes are sealed in a packaging at atmospheric pressure or under vacuum, in order to preserve their integrity.

In order to ensure that the sealing is perfectly leaktight, the leaktightness of the sealed product is tested. The test must have good sensitivity in order to ensure that the sealing has good leaktightness for various types of dry or liquid, flexible or rigid, opaque or transparent, etc. products. For the pharmaceutical and agri-food industries, this test is essential for ensuring the stability of the medicament or of the food product by protecting it from moisture, air and bacteria.

Several methods exist for testing the leaktightness of sealed products.

Document EP2875328B1 discloses a detection method for checking the leaktightness of sealed products in which at least one product which has been previously sealed in an air, nitrogen or argon atmosphere is placed in an enclosure, the pressure in the enclosure is lowered to a high vacuum pressure by a turbomolecular vacuum pump and, while continuing the high vacuum pumping in the enclosure, the gases contained in the enclosure are ionized in order to monitor the evolution, in the enclosure, of the concentration of at least one ionized gas species of the gas volume contained in the sealed product from among nitrogen, oxygen or argon, via analysis by optical emission spectrometry or mass spectrometry. The detection method uses the fact that the sealed products contain a gas atmosphere trapped between the element to be protected and the packaging. The study, in the enclosure, of the gas species contained in this gas volume therefore makes it possible to identify the presence of a leak from the sealed product. It is then no longer necessary to pierce and replug the packaging in order to fill it with tracer gas. No particular step is necessary between the sealing of the product being produced, the leak test and the marketing of the leak-free sealed product.

However, certain industries require very high levels of sensitivity in order to detect particularly small leaks, notably smaller than 0.5 μm, i.e. 4.10⁻⁵ mbar.l/s or 4.10⁻⁶ Pa. m³/s, or even 0.2 μm, i.e. 6.10⁻⁶ mbar.l/s or 6.10⁻⁷ Pa.m³/s, in particular in the pharmaceutical industry in order to ensure the sterility threshold. It is thus essential to lower the background noise of the test method in order to have sufficient sensitivity.

When nitrogen is the gas species whose evolution in the enclosure is monitored, the nitrogen signal measured may originate from a leak from the sealed product that is desired to be detected, but also from the degassing of the walls, notably of the walls of the enclosure, of the walls of the sealed product, or even of the walls of the detector chamber and of the vacuum line due to their intermittent placing in communication with the enclosure, at intermediate pressure. It is possible to lower this background noise by waiting a long time at maximum pumping, referred to as ultimate vacuum. However, at ultimate vacuum, another source of parasitic nitrogen background noise originates from the backstreaming of gases through the turbomolecular vacuum pump.

It is therefore desired to reduce the nitrogen background noise that may originate from the degassing of the walls or from the backstreaming through the vacuum pump in order to carry out a sensitive detection. Nevertheless, below a very low pressure, it is no longer possible to maintain an ignited plasma in the detector chamber for a sufficiently long duration to carry out a leak test.

### SUMMARY OF THE INVENTION

An aim of the present invention is to at least partially overcome this drawback by proposing a device and a method for the high-sensitivity detection of leaks from products sealed under a nitrogen-containing atmosphere, notably in order to meet pharmaceutical standards.

To this end, a subject of the invention is a detection device for checking the leaktightness of sealed products, comprising:
an enclosure configured to receive at least one product which has been sealed under a nitrogen-containing atmosphere,
a turbomolecular vacuum pump,
an ionized gas gage, characterized in that the detection device further comprises:
a buffer volume fluidically connected to a chamber of the ionized gas gage,
an isolation valve interposed between the enclosure and the buffer volume and configured to place the buffer volume in communication with, or isolate it from, the enclosure,
a conductance-variable restriction interposed between the inlet of the turbomolecular vacuum pump and the buffer volume, the conductance-variable restriction having a variable opening, and
a gas injection device configured to inject a variable flow rate of replacement gas distinct from nitrogen into the enclosure containing the sealed product.

The injection of replacement gas into the enclosure combined with the flow reduction at the intake of the turbomolecular vacuum pump makes it possible to adapt the pressure in the enclosure and therefore in the chamber of the ionized gas gage in order to achieve a test pressure compatible with the generation and maintenance of a plasma. The pressure obtained is thus the lowest possible pressure for the ignition and maintenance of a plasma, thus making it possible to obtain a test of high sensitivity. The continuous injection of replacement gas into the enclosure furthermore makes it possible to prevent the backstreaming of nitrogen into the enclosure through the turbomolecular vacuum pump by directing the flow toward the delivery of the turbomolecular vacuum pump. The conductance-variable restriction makes it possible to reduce the pumping flow in order to increase the pressure while retaining the high compression rate of the turbomolecular vacuum pump, thus also making it possible to prevent the backstreaming of gas species through the turbomolecular vacuum pump. Also, this makes it possible to inject less replacement gas during the test, thus avoiding overwriting the nitrogen signal with that of the replacement gas. Moreover, the variable conductance of the restriction makes it possible to increase the conductance for rapid pumping of the enclosure from atmospheric pressure.

The detection device may also have one or more of the features described below, considered alone or in combination.

The detection device may comprise a control unit.

The control unit may be configured to control the variable opening of the conductance-variable restriction in dependence on a control parameter of the ionized gas gage in order to ignite or maintain a plasma in the chamber.

The control unit may be configured to control the flow rate of the gas injection device in dependence on a control parameter of the ionized gas gage in order to ignite or maintain a plasma in the chamber.

The conductance-variable restriction comprises, for example, a diaphragm.

The control parameter of the ionized gas gage is, for example, the voltage of a generator of a plasma generation device of the ionized gas gage.

According to one exemplary embodiment, the ionized gas gage comprises:
a chamber,
a plasma generation device configured to generate a plasma in the chamber,
an optical emission spectrometer,
an optical window allowing the light emitted by the plasma to be analyzed by the optical emission spectrometer.

According to one exemplary embodiment, the ionized gas gage comprises a plasma generation device comprising:
a cathode comprising a cylindrical wall connected to at least one disk having a central hole and at least two peripheral holes,
a rectilinear anode arranged at the center of the cathode and passing through the disks of the cathode,
at least one toric magnet surrounding the chamber, and
a generator connected to the cathode and the anode.

The detection device may comprise a calibrated leak, connected to the enclosure, comprising a capillary and an isolation valve which are interposed between a nitrogen dispenser and the enclosure.

A further subject of the invention is a detection method for checking the leaktightness of sealed products in a detection device as described above, comprising the following steps:
in a first step, at least one product which has been previously sealed under a nitrogen-containing atmosphere is placed in the enclosure,
in a second step, the isolation valve is opened so as to place the enclosure in communication with the buffer volume under vacuum,
in a third step, a replacement gas distinct from nitrogen is continuously injected into the enclosure and, while continuing the high vacuum pumping in the enclosure, the gases contained in the enclosure are ionized by means of the ionized gas gage in order to monitor the evolution, in the enclosure, of the nitrogen concentration via analysis by optical emission spectroscopy and identify the presence of a leak from said sealed product, the opening of the conductance-variable restriction and the flow rate of the gas injection device being controlled so as to generate and maintain an ignited plasma in the chamber of the ionized gas gage.

According to one exemplary embodiment, in the second step, the opening of the conductance-variable restriction is maximal and the flow rate of the gas injection device is minimal.

According to one exemplary embodiment, in the third step, as the pressure in the enclosure progressively drops, the opening of the conductance-variable restriction is first reduced before the flow rate of the gas injection device is increased in order to maintain the ignited plasma.

The detection method may comprise a fourth step in which the isolation valve is closed while the replacement gas continues to be injected for the return to atmospheric pressure in the enclosure.

A replacement gas may also be injected into the enclosure in order to sweep the walls of the enclosure with replacement gas during the first step.

The replacement gas is for example selected from among argon, xenon, helium, carbon dioxide, krypton and neon.

According to one exemplary embodiment, a calibration test is carried out with an intact sealed product contained in the enclosure into which a known flow rate of nitrogen is injected via a calibrated leak of the detection device.

### BRIEF DESCRIPTION OF THE FIGURES

Further features and advantages of the invention will become apparent from the following description, given by way of non-limiting example, with reference to the appended drawings, in which:

FIG. 1 is a schematic view of a detection device for checking the leaktightness of sealed products.

FIG. 2A is a schematic front view of one exemplary embodiment of a conductance-variable restriction of the detection device in FIG. 1 with a maximum opening.

FIG. 2B is a view similar to FIG. 2A with a partially closed opening.

FIG. 3 is a schematic view in section of elements of one exemplary embodiment of an ionized gas gage of the detection device.

FIG. 4 shows a diagram of the steps of a detection method implemented in the detection device.

FIG. 5A shows one example of a spectrum obtained for a leak test for a sealed product, without replacement gas.

FIG. 5B shows another example of a spectrum obtained for a leak test for a sealed product, for which the replacement gas is argon.

In these figures, identical elements bear the same reference numbers.

### DETAILED DESCRIPTION

The following embodiments are examples. Although the description refers to one or more embodiments, this does not necessarily mean that each reference relates to the same embodiment, or that the features apply only to one embodiment. Individual features of different embodiments may also be combined or interchanged to provide other embodiments.

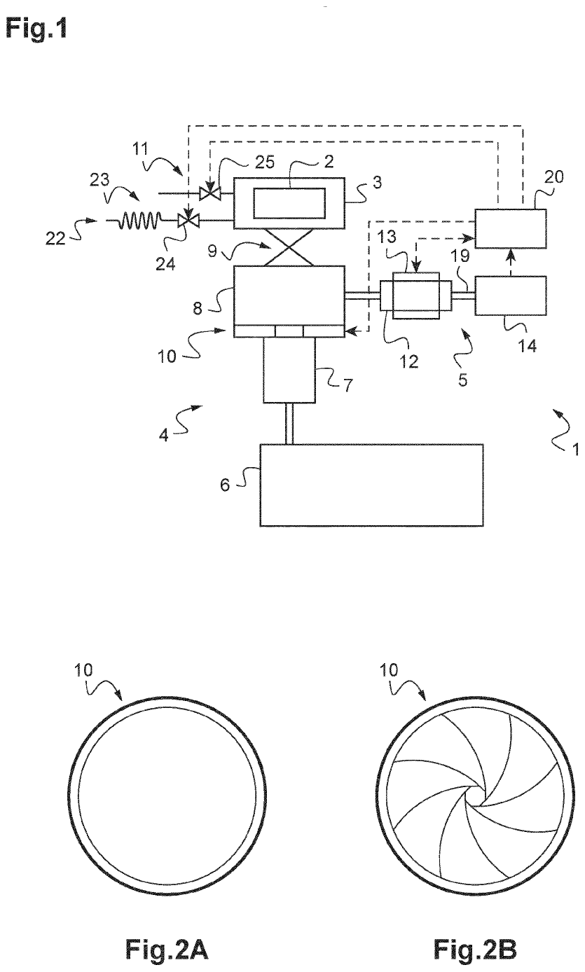

FIG. 1 depicts a detection device 1 for checking the leaktightness of sealed products 2.

The sealed products 2 are, for example, pharmaceutical or food products, such as sealed blister packs, sachets, vials, pouches, pharmaceutical or medical bags, and syringes. The sealed products 2 may also be products from the biotechnology industry, watchmaking industry or automotive industry.

These products contain at least one element to be protected, for example from moisture, air or bacteria, such as a medicament or a foodstuff. The element to be protected may be in liquid or solid form. It is packed in a sealed packaging. Intact sealing ensures that access to the inside of the packaging is impossible, no gas can enter or leave the packaging.

The sealed product 2 contains nitrogen, or a gas mixture containing nitrogen such as air, between the element to be protected and its packaging. The pressure in the gas volume contained in the sealed product 2 is therefore constant. This may be atmospheric pressure or a subatmospheric pressure for “vacuum” packs, depending on their packaging. This may also be a reservoir at an overpressure of the airbag or other type.

The detection device 1 comprises an enclosure 3 configured to receive at least one product 2 which has been sealed under a nitrogen-containing atmosphere, a pumping unit 4 and an ionized gas gage 5.

The enclosure 3 has a volume which can contain one or more sealed products 2 and which has dimensions slightly greater than the volume of the sealed product or products 2 to be tested, so as to limit as much as possible the absorption of gases by the surfaces of the enclosure 3 when the latter is at atmospheric pressure for the loading/unloading of the sealed product 2. Thus the degassing from the walls of the enclosure 3 at low pressure, which could increase the background noise, is limited. In addition, a volume just slightly greater than the volume of the sealed product 2 makes it possible to more rapidly lower the pressure in the enclosure 3 and therefore to improve the response time and the sensitivity of the measurement, the measurement volume being equal to the volume of the enclosure 3 from which the volume of the sealed product 2 has been subtracted.

The enclosure 3 is adapted to be able to be placed under vacuum by the pumping unit 4.

The pumping unit 4 comprises a rough-vacuum pump 6 and a turbomolecular vacuum pump 7 which are fluidically connected in series, the inlet of the rough-vacuum pump 6 being fluidically connected to the outlet of the turbomolecular vacuum pump 7. The turbomolecular vacuum pump 7 is configured to provide a high vacuum in the enclosure 3 at ultimate vacuum, that is to say without injection of gas, lower than or equal to 10⁻⁵ mbar (10⁻³ Pa), such as between 10⁻⁵ mbar (10⁻³ Pa) and 10⁻⁷ mbar (10⁻⁵ Pa).

The detection device 1 further comprises a buffer volume 8, an isolation valve 9 interposed between the enclosure 3 and the buffer volume 8, a conductance-variable restriction 10 interposed between the inlet of the turbomolecular vacuum pump 7 and the buffer volume 8, and a gas injection device 11 configured to inject a variable flow rate of replacement gas distinct from nitrogen into the enclosure 3 containing the sealed product 2.

The conductance-variable restriction 10 has a variable opening, thus making it possible to reduce the conductance between the buffer volume 8 and the turbomolecular vacuum pump 7, that is to say the size of the passage for gases between the turbomolecular vacuum pump 7 and the buffer volume 8, while allowing continuous pumping of the buffer volume 8 by the turbomolecular vacuum pump 7.

The conductance-variable restriction 10 comprises, for example, a diaphragm. The diaphragm may be, for example, completely open (FIG. 2A) or partially closed (FIG. 2B) with several possible degrees of closure. The variation in size of the opening is for example continuous.

The isolation valve 9 may either be opened so as to place the buffer volume 8 in communication with the enclosure 3 and thus place the enclosure 3 under vacuum by means of the buffer volume 8, or closed so as to isolate the buffer volume 8 from the enclosure 3, notably in order to open the enclosure 3 to atmospheric pressure for the unloading and loading of sealed products 2 to be tested and, at the same time, lower the pressure in the buffer volume 8 by means of the turbomolecular vacuum pump 6.

The buffer volume 8 is thus continually placed under vacuum by the turbomolecular vacuum pump 7. The pressure in the buffer volume 8 does not rise to atmospheric pressure, thus making it possible to avoid the absorption of gases by the surfaces. The buffer volume 8 is for example between 0.5 dm³ and 2 dm³, such as 1 dm³.

The replacement gas injection device 11 is configured to inject a variable flow rate of replacement gas distinct from nitrogen into the enclosure 3 containing the sealed product 2 and for this purpose comprises, for example, a flow rate controller 25.

The replacement gas is injected into the enclosure 3, on the one hand, during the test for identifying the presence of a leak from the sealed product 2, and possibly for returning the enclosure 3 to atmospheric pressure and, as will be seen below, for sweeping the enclosure 3 at atmospheric pressure during the loading/unloading of sealed products 2 to be tested. As an alternative, a specific additional gas injection line is used for the return to atmospheric pressure and/or for the sweeping of the enclosure 3 at atmospheric pressure.

The replacement gas is a gas distinct from nitrogen in order to avoid any confusion with the nitrogen contained in the sealed product 2.

The replacement gas is, for example, argon. Argon has the advantage of facilitating the interpretation of the spectrum, notably because the spectral lines of argon are distant from the spectral lines of nitrogen. In addition, it is a neutral gas, readily available, inexpensive and it facilitates the initiation of a plasma. According to other examples, the replacement gas is xenon, helium, carbon dioxide, krypton or neon. The replacement gas may also comprise a mixture of gases that are distinct from nitrogen.

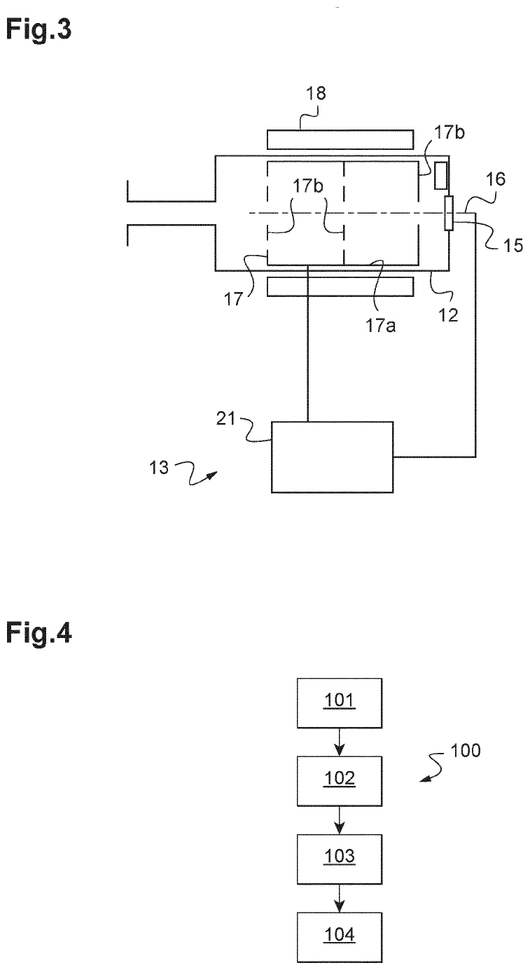

As better visible in FIGS. 1 and 3, according to one exemplary embodiment, the ionized gas gage 5 comprises a chamber 12 fluidically connected to the buffer volume 8, a plasma generation device 13 configured to generate a plasma in the chamber 12, an optical emission spectrometer 14 configured to provide a spectrum from the light emitted by the plasma, and an optical window 15, such as a transparent viewing window, allowing the light emitted by the plasma to be analyzed by the optical emission spectrometer 14.

The chamber 12 connected to the buffer volume 8 by its open end can thus be placed under vacuum continuously by virtue of the buffer volume 8.

According to one exemplary embodiment, the plasma generation device 13 of the ionized gas gage 5 comprises an anode 16 (+pole) and a cathode 17 (−pole) respectively connected to the positive and negative poles of a generator 21 (FIG. 3). The cathode 17 comprises a cylindrical wall 17a connected to at least one disk 17b, for example three distributed along the axis of the cylindrical wall 17a, each having a central hole through which the anode 16 passes and being able to have at least two peripheral holes, for example six regularly distributed around the central hole. The rectilinear anode 16 is arranged at the center of the cathode 17, with which it is isolated, and passes through the disks 17b of the cathode 17.

The generator 21 of the plasma generation device 13 is configured to apply, between the anode 16 (positively charged) and the cathode 17 (negatively charged), a high potential difference, for example greater than or equal to 3000 volts, which generates a radial electric field E. In practice, the generator 21 provides, for example, a fixed current, the voltage being a variable control parameter which is dependent notably on the pressure in the chamber 12 of the ionized gas gage 5.

This field E makes it possible to create a plasma by generation and acceleration of a stream of electrons from the cathode 17 toward the anode 16 in order to excite and ionize the gas molecules originating from the enclosure 3. In order to obtain a usable plasma, added thereto is a magnetic field B of constant intensity, around 100 mT, and of given direction, the field lines of which are perpendicular to the electric field E and parallel to the anode 16. The magnetic field B is generated by at least one permanent toric magnet 18 surrounding the chamber 12. The presence of a magnetic field B coupled to the electric field E makes it possible to greatly increase the excitation of the plasma gas molecules.

Thus a plasma can be generated inside this chamber 12 by the plasma generation device 13 in order to be able to analyze the gas species present in the enclosure 3. The plasma generated over the gas species emits light that originates from the deexcitation of the characteristic molecules of the gases present. The light that passes through the optical window 15 is collected for example by an optical collector system and analyzed spectrally by the optical emission spectrometer 14, which are optically connected for example via a fiber 19 which transports light from the optical collector to the spectrometer 14 (FIG. 1).

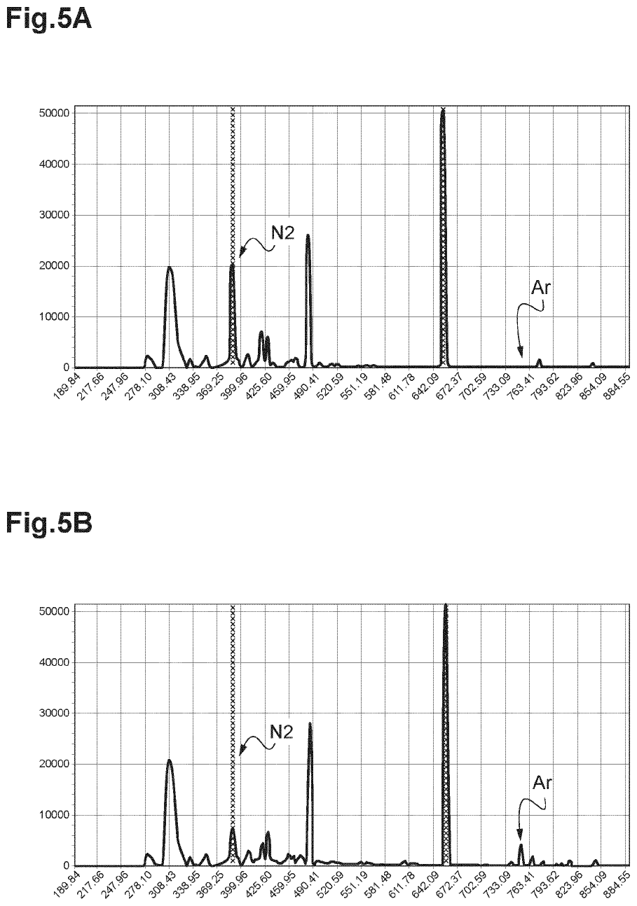

In optical emission spectrometry, the charged molecules (ions) are separated in dependence on the wavelength at which they emit. The amplitude of a peak from the spectrum (or spectral line) corresponds to the relative abundance of a molecule fragment. The spectrometer 14 establishes the characteristic spectrum of the gas species present in the chamber 12. The wavelengths of the lines of the optical spectrum thus obtained are characteristic of the gas species present in the enclosure 3 (FIGS. 5A, 5B).

The detection method uses the fact that the sealed products 2 contain a nitrogen-containing gas atmosphere trapped between the element to be protected and the packaging. Monitoring the evolution of nitrogen therefore makes it possible to identify the presence of a leak from the sealed product 2. A leak is detected for example by comparing at least one nitrogen line of the spectrum obtained with a nitrogen line of a spectrum of a reference sealed product 2, i.e. free from leaks, or by observing the presence of a nitrogen line, notably for example by comparing the amplitude of the nitrogen line in the spectrum obtained with a maximum threshold to not be exceeded so that the sealed product is considered to be intact.

The detection device 1 may also comprise a calibrated leak 22 connected to the enclosure 3 (FIG. 1). A “calibrated leak” is understood to mean a leak having characteristics that are known. The calibrated leak can be used to obtain the spectrum of a reference sealed product 2.

To do so, a calibration test is carried out with an intact sealed product 2 contained in the enclosure 3 into which a known flow rate of nitrogen is injected via the calibrated leak 22.

According to one exemplary embodiment, the calibrated leak 22 comprises a capillary 23 and an isolation valve 24 which are interposed between a nitrogen dispenser and the enclosure 3. The capillary 23 makes it possible to deliver a known and constant flow rate of nitrogen. The intact sealed product 2 contained in the enclosure 3 at the time of this measurement makes it possible to add the source of degassing from the walls of the sealed product 2 to the reference signal.

The detection device 1 may comprise a control unit 20, such as a computer, automaton or controller, connected to the optical emission spectrometer 14 in order to receive from the latter signals representative of the evolution of the ionized gas species in the chamber 12 and in order to identify whether a characteristic wavelength of nitrogen is present in the spectrum so as to identify a leak.

According to one exemplary embodiment, the control unit 20 is configured to control the variable opening of the conductance-variable restriction 10 and/or the flow rate of the gas injection device 11 in dependence on a control parameter of the ionized gas gage 5 in order to ignite or maintain a plasma in the chamber 12.

The control parameter of the ionized gas gage 5 is, for example, the voltage of a generator of the plasma generation device 13.

The control unit 20 may also be configured to control the isolation valve 24 of the calibrated leak 22, where appropriate.

During operation, the detection method 100 for checking the leaktightness of sealed products 2 in the detection device 1 comprises the steps that follow (FIG. 4).

It is considered that the isolation valve 9 is initially closed, the enclosure 3 being isolated from the buffer volume 8, the buffer volume 8 being placed under vacuum by the turbomolecular vacuum pump 7, the delivery of which is kept under rough vacuum by the rough-vacuum pump 6.

In a first step 101, at least one product 2 which has been previously sealed under a nitrogen-containing atmosphere, for example which has been sealed under air or under nitrogen, is placed in the enclosure 3. This first step 101 is carried out at the pressure of the atmosphere outside of the enclosure 3, for example atmospheric pressure.

According to one exemplary embodiment, a replacement gas is injected into the enclosure 3 during the first step 101 in order to sweep the walls of the enclosure 3 with replacement gas. This sweeping of the walls by a replacement gas while the enclosure 3 is opened for the unloading/loading of a sealed product 2 to be tested makes it possible to prevent the walls of the enclosure 3 from being able to be charged with gas species originating from the ambient air and from increasing the background noise when the enclosure 3 is placed under vacuum. Then, the enclosure 3 is closed.

In a second step 102, the isolation valve 9 is opened so as to place the enclosure 3 in communication with the buffer volume 8 under vacuum, thus lowering the pressure in the enclosure 3 and in the chamber 12 of the ionized gas gage 5. The opening of the conductance-variable restriction 10 is for example maximal and the flow rate of the gas injection device 11 is for example minimal. The high vacuum (or test pressure) obtained is for example between 10⁻² mbar (1 Pa) and 10⁻⁷ mbar (10⁻⁵ Pa).

The conductance-variable restriction 10 makes it possible to increase the pumping flow rate in order to obtain the test pressure in the enclosure 3 rapidly during the first step 101, for different degassing rates of sealed products. Specifically, the variable conductance arranged in front of the turbomolecular vacuum pump 7 makes it possible to increase the passage section and therefore the conductance in order to lower the pressure from atmospheric pressure as quickly as possible after the loading of a sealed product 2 and to maintain this maximum pumping up to the end of the degassing. The degassing duration can then be adapted depending on the degassing rate of the sealed product 2 in order to prevent it from taking several hours for example for containers that degas a lot, such as those made of plastics material.

In a third step 103, a replacement gas distinct from nitrogen is continuously injected into the enclosure 3 by means of the replacement gas injection device 11, for example at an initial flow rate of 10⁻³ mbar.l/s, i.e. 10⁻⁴ Pa.m³/s, and, while continuing the high vacuum pumping in the enclosure 3, the gases contained in the enclosure 3 are ionized by means of the ionized gas gage 5 in order to monitor the evolution, in the enclosure 3, of the nitrogen concentration via analysis by optical emission spectroscopy and identify the presence of a leak from said sealed product 2.

The opening of the conductance-variable restriction 10 and the flow rate of the gas injection device 11 are controlled so as to be able to generate and maintain an ignited plasma in the chamber 12 of the ionized gas gage 5.

The continuous injection of replacement gas into the enclosure 3 combined with the flow reduction 10 at the intake of the turbomolecular vacuum pump 7 makes it possible to adapt the pressure of the gases inside the enclosure 3 and therefore in the chamber 12 of the ionized gas gage 5 in order to achieve test pressures compatible with the generation and maintenance of a plasma in the chamber 12.

The continuous injection of replacement gas into the enclosure 3 makes it possible to prevent the backstreaming of nitrogen into the enclosure 3 through the turbomolecular vacuum pump 7 by directing the flow toward the delivery of the turbomolecular vacuum pump 7.

The conductance-variable restriction 10 makes it possible to reduce the pumping flow while retaining the high compression rate of the turbomolecular vacuum pump 7, thus also making it possible to prevent the backstreaming of gas species through the turbomolecular vacuum pump 7. In addition, the reduction of the pumping flow with respect to the maximum pumping for placing under vacuum makes it possible to inject less replacement gas to achieve the desired test pressures. This reduced injection of replacement gas makes it possible for the nitrogen signal to not be overwritten with that of the replacement gas. Specifically, a lower power is necessary for the generator 21 of the plasma generation device 13, thus rendering visible the nitrogen partial pressure signal.

The pressure obtained is thus the lowest possible pressure for the maintenance of a plasma, thus making it possible to obtain high sensitivity.

In practice for example in order to maintain the ignited plasma, it is desired to maintain a constant current. To do so, for example, as the pressure in the enclosure 3 progressively drops, the voltage of the generator 21 of the plasma generation device 13 is first of all increased. When this voltage reaches a maximum, for example 5000 volts, the opening of the conductance-variable restriction 10 is first reduced before the flow rate of the gas injection device 11 is increased. The flow rate may for example be increased to 101 mbar.l/s, i.e. 1 Pa.m³/s.

After the leak test has been carried out, in a fourth step 104, the isolation valve 9 is closed for example while the replacement gas continues to be injected for the return to atmospheric pressure in the enclosure 3. The replacement gas injected makes it possible to saturate the inner walls of the enclosure 3 and of the chamber 12 of the ionized gas gage 5, thus making it possible to reduce the adsorption rate of the walls by ambient air, and notably by nitrogen, and consequently to reduce the time necessary for the degassing between two measurements and therefore the cycle time.

The graphs depicted in FIGS. 5A and 5B show two examples of spectra obtained via measurement by optical emission spectroscopy for checking the leaktightness of packagings of intact sealed products 2 by monitoring the amplitude of the peak of a nitrogen line contained in the enclosure 3, also present in the sealed product 2.

On the spectrum in FIG. 5B in which argon is the replacement gas, the amplitude of the monitored nitrogen spectral line (around 389 nm) is lower than on the spectrum in FIG. 5A which has no replacement gas. The replacement gas therefore makes it possible to reduce the nitrogen background noise. Moreover, the increase in the amplitudes of the argon spectral lines in the spectrum in FIG. 5B, due to the fact that the replacement gas is argon, does not constitute a hindrance for the monitoring of the nitrogen line because the argon lines are distant from the monitored nitrogen line.

It will therefore be understood that the detection device 1 makes it possible to carry out a high-sensitivity detection of leaks from sealed products 2 that notably meets pharmaceutical standards.

1-13. (canceled)

14. A detection device for checking a leaktightness of sealed products, comprising:
an enclosure configured to receive at least one product that has been sealed under a nitrogen-containing atmosphere;
a turbomolecular vacuum pump;
an ionized gas gage;
a buffer volume fluidically connected to a chamber of the ionized gas gage;
an isolation valve interposed between the enclosure and the buffer volume and configured to place the buffer volume in communication with, or isolate the buffer volume from, the enclosure;
a conductance-variable restriction interposed between an inlet of the turbomolecular vacuum pump and the buffer volume, the conductance-variable restriction having a variable opening;
a gas injection device configured to inject a variable flow rate of replacement gas distinct from nitrogen into the enclosure containing the sealed product; and
a control unit configured to control the variable opening of the conductance-variable restriction and/or the flow rate of the gas injection device in dependence on a control parameter of the ionized gas gage in order to ignite or maintain a plasma in the chamber.

15. The detection device as claimed in claim 14, wherein the control parameter of the ionized gas gage is a voltage of a generator of a plasma generation device.

16. The detection device as claimed in claim 14, wherein the conductance-variable restriction comprises a diaphragm.

17. The detection device as claimed in claim 14, wherein the ionized gas gage comprises:
a chamber;
a plasma generation device configured to generate a plasma in the chamber;
an optical emission spectrometer; and
an optical window allowing light emitted by the plasma to be analyzed by the optical emission spectrometer.

18. The detection device as claimed in claim 17, wherein the plasma generation device comprises:
a cathode comprising a cylindrical wall connected to at least one disk having a central hole and at least two peripheral holes,
a rectilinear anode arranged at the center of the cathode and passing through the disks of the cathode,
at least one toric magnet surrounding the chamber, and
a generator connected to the cathode and the anode.

19. The detection device as claimed in claim 14, wherein the detection device comprises a calibrated leak, connected to the enclosure, comprising a capillary and an isolation valve that are interposed between a nitrogen dispenser and the enclosure.

20. A detection method for checking the leaktightness of sealed products in the detection device as claimed in claim 14, comprising the following steps:
in a first step, placing at least one product that has been previously sealed under a nitrogen-containing atmosphere in the enclosure;
in a second step, opening the isolation valve so as to place the enclosure in communication with the buffer volume under vacuum;
in a third step, continuously injecting a replacement gas distinct from nitrogen into the enclosure and, while continuing a high vacuum pumping in the enclosure, the gases contained in the enclosure are ionized via the ionized gas gage in order to monitor an evolution, in the enclosure, of a nitrogen concentration via analysis by optical emission spectroscopy and identify a presence of a leak from said sealed product, the opening of the conductance-variable restriction and the flow rate of the gas injection device being controlled so as to generate and maintain an ignited plasma in the chamber of the ionized gas gage.

21. The detection method as claimed in claim 20, wherein, in the second step, the opening of the conductance-variable restriction is maximal and the flow rate of the gas injection device is minimal.

22. The detection method as claimed in claim 21, wherein, in the third step, as a pressure in the enclosure progressively drops, the opening of the conductance-variable restriction is first reduced before the flow rate of the gas injection device is increased in order to maintain the ignited plasma.

23. The detection method as claimed in claim 20, further comprising, in a fourth step, closing the isolation valve while the replacement gas continues to be injected for a return to atmospheric pressure in the enclosure.

24. The detection method as claimed in claim 20, wherein a replacement gas is injected into the enclosure in order to sweep walls of the enclosure with replacement gas during the first step.

25. The detection method as claimed in claim 20, wherein the replacement gas is selected from among argon, xenon, helium, carbon dioxide, krypton and neon.

26. The detection method as claimed in claim 20, wherein a calibration test is carried out with an intact sealed product contained in the enclosure into which a known flow rate of nitrogen is injected via a calibrated leak of the detection device.
